(19) United States
(12) Patent Application Publication
(10) Pub. No.: US 2002/0147575 A1
(43) Pub. Date: Oct. 10, 2002

(54) Method and system for modeling dielectric losses in a transmission line

(76) Inventors: Karl J. Bois, Fort Collins, CO (US); David W. Quint, Fort Collins, CO (US); Quan Qi, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/782,106

(22) Filed: Feb. 12, 2001

(51) Int. Cl. G06F 17/50; G06F 7/60

(52) U.S. Cl. 703/14; 703/2

(57) ABSTRACT

A software method is disclosed for modeling dielectric losses in transmission lines, such as lines on a computer chip or circuit board, using a circuit simulation application, such as a SPICE program. Line resistance, self-inductance, and self-capacitance are calculated and modeled as a lumped element circuit having a resistor and an inductor connected in series, with a capacitance in parallel. A two-port scattering matrix is used to model the dielectric losses. The method uses a matrix that is related to the dielectric constant of the medium surrounding the line, the length of the line, and the frequency of the signal. The method assumes low loss conditions typical of circuit boards or integrated circuit chips, whereby the intrinsic impedance of the line is not affected by losses and the matrix is normalized to the intrinsic impedance.

### FIELD OF INVENTION

The present invention relates generally to simulation of electrical connections. More particularly, it relates to SPICE simulation of dielectric losses in transmission lines on a chip or circuit board.

### BACKGROUND

Transmission lines refer to any conductors that carry electric signals, including conductors on integrated circuit (IC) chips, microchips, and circuit boards. Transmission lines have an intrinsic resistance (R) and inductance (L) based on the properties of the lines. Transmission lines also have an intrinsic capacitance (C) and conductance (G) based on their proximity to other lines and on the dielectric between the lines. These values are stated per-unit-length of the lines. Resistance is measured in ohms per meter (Ω/m), inductance is self-inductance measured in henries per meter (H/m), capacitance is self-capacitance measured in farads per meter (F/m), and conductance represents the dielectric losses measured in mohs per meter (Ω⁻¹/m). The resistance, inductance, and conductance of the transmission lines varies with the frequency of the transmitted signal due to skin effect losses. As the frequency increases, the conductance increases; that is, the shunt resistance converges to zero.

When designing circuits, it is desirable to calculate values for transmission lines to determine the resistance, inductance, capacitance, and conductance. Circuits may be modeled using software systems, such as simulation programs with integrated circuit emphasis (SPICE) simulations. A desired method of modeling transmission line losses is through a lumped element model having a resistor in series with an inductor, followed by a capacitor and a conductance in parallel.

To model the skin effect losses, an R-L tank circuit may be used to represent the skin effect on the resistance and capacitance. Existing methods do not provide an accurate method for modeling dielectric losses caused by the dielectric surrounding the conductors. Existing methods simply use the same value of G for all frequencies. This causes erroneous simulations in broadband systems, particularly as frequencies exceed 1 GHz, because the value G is modeled as if it approaches zero with higher frequencies. At higher frequencies, G is modeled as a short circuit, indicating that all of the energy is reflected toward the input. This method is accurate only if the input signal is a perfectly sinusoidal wave at a single frequency. For any other signal, such as a digital signal, this is inaccurate because the energy will actually dissipate along the lines as it returns to the source. What is needed is a method of accurately modeling dielectric losses in transmission lines at high frequencies.

### SUMMARY OF INVENTION

A software method is disclosed for modeling dielectric losses in transmission lines, such as lines on a computer chip or circuit board, using a circuit simulation application, such as a SPICE program. Line resistance, self-inductance, and self-capacitance are calculated and modeled as a lumped element circuit having a resistor and an inductor connected in series, with a capacitance in parallel. A two-port scattering matrix is used to replace the conductance and to better represent the dielectric losses as a function of frequency. The method uses a matrix that is related to the dielectric constant of the medium surrounding the line, the length of the line, and the frequency of the signal. The method assumes low loss conditions typical of circuit boards or integrated circuit chips, whereby the intrinsic impedance of the line is not affected by losses and the matrix is normalized to the intrinsic impedance.

### SUMMARY OF DRAWINGS

FIG. 1 shows a layout of transmission lines on a chip.

FIG. 2 shows a schematic of a lumped element circuit.

FIG. 3 shows a schematic of a lumped element circuit with an R-L tank.

FIG. 4 shows a schematic of a lumped element circuit connected to a two-port scattering matrix.

FIG. 5 shows a block diagram of the computer system that uses the method.

FIG. 6 shows a flow chart of the method.

### DETAILED DESCRIPTION

A method and system are disclosed for simulating dielectric losses associated with transmission lines. FIG. 1 shows a circuit medium 10, such as an integrated circuit (IC) chip or a circuit board. The medium 10 has a plurality of transmission lines 12, 12′ that carry signals throughout the medium 10. The transmission lines 12 are separated by a dielectric 14.

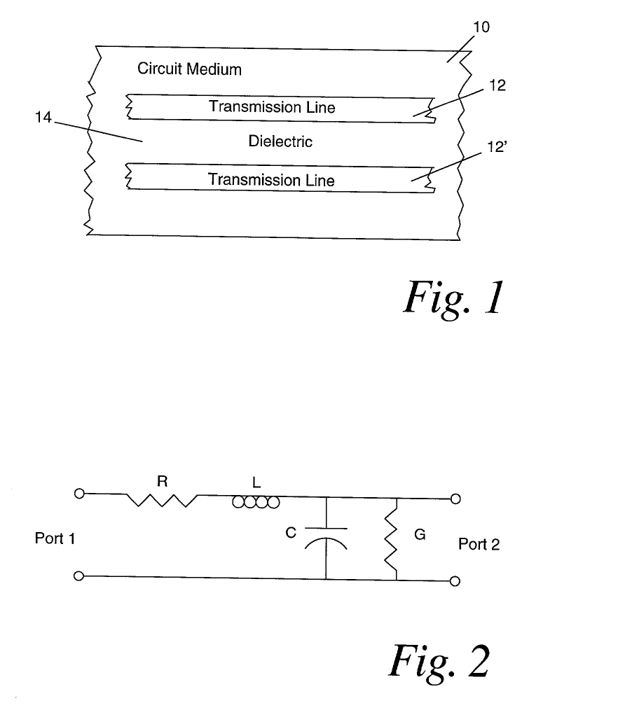

FIG. 2 shows a schematic circuit model of a transmission line 12. This model may be used in a software simulation of a circuit, such as a SPICE application, to measure the performance of the lines 12, 12′. The line 12 has a resistance (R), a self-inductance (L), and a self-capacitance (C). The line 12 also has a conductance (G) that is a function of dielectric losses. These values depend in part on the geometry of the system. R and G represent losses in the system. L and C represent the lumped inductance and capacitance of the lines and will affect the speed of propagation of a signal through the line and intrinsic impedance. In one implementation, the circuit model of FIG. 2 may be repeated multiple times and connected port-to-port, with each model representing a small segment of the line 12.

At lower frequencies, the schematic shown in FIG. 2 accurately models the characteristics of the line 12. At middle-range frequencies (10 MHz-100 MHz) the model breaks down due to the phenomenon known as the skin effect. A line 12 will carry a direct current signal generally uniformly throughout its cross-section. With an alternating current signal, more current is carried near the outer portion of the line 12 than at the interior, which is known as the skin effect. As frequency increases, the skin effect becomes more pronounced and the resistance increases.

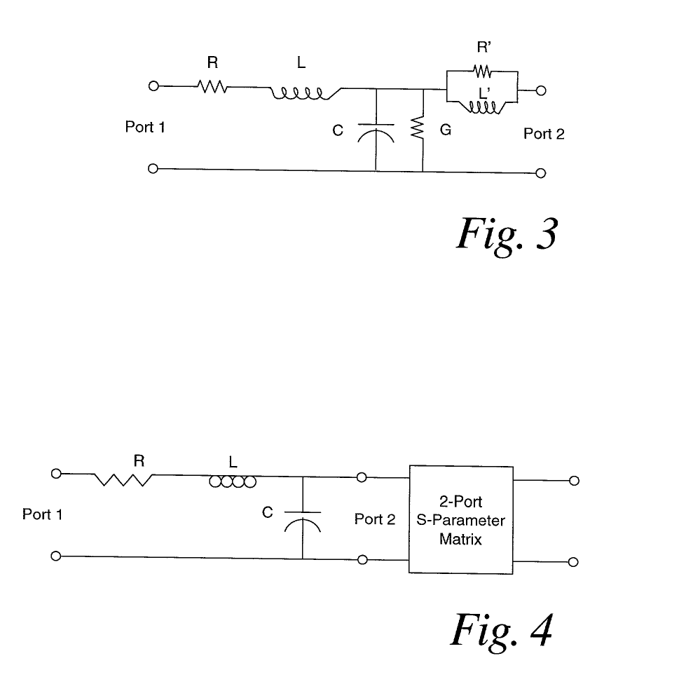

FIG. 3 shows a circuit model of the transmission line 12 in one method of accounting for the skin effect. An R-L tank circuit is added to the schematic with a tank resistance R′ and a tank inductance L′. The R-L tank only represents the conductor losses—that is, the skin effect. At higher frequencies, such as those above 1 GHz, the model is again inaccurate due to dielectric losses, which represent the attenuative properties of the dielectric material surrounding the conductors 12. The conductance does not accurately model the dielectric losses as a function of frequency. Using this model at increasingly higher frequencies, the conductance will result in a short circuit, reflecting all of the energy back to the driving source. This is contrary to the actual mechanism of dielectric loss where the energy is dissipated in the dielectric surrounding the conductors 12. Tests on a circuit using a matched load reveal the true characteristics of the conductance, which may be modeled as a scattering matrix element.

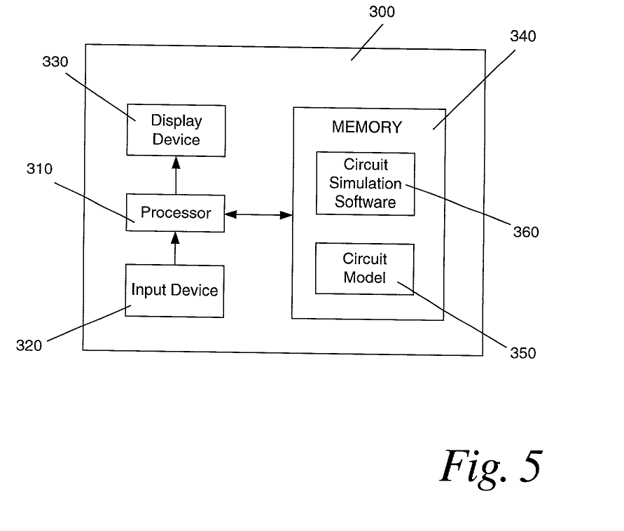

FIG. 4 shows a two-port S-parameter matrix that represents the performance of G modeled as being connected in parallel to the lumped element circuit. As used herein, an S-parameter matrix, [S], refers to any matrix used to represent a two port circuit element. The scattering matrix relates the voltage waves incident on the ports to those reflected from the ports, and may be shown in the form

$$[ S ] = [ \begin{matrix}{S}_{11} & {S}_{12} \\ {S}_{21} & {S}_{22}\end{matrix} ] .$$

In this embodiment, the matrix may be applied to transmission lines 12 having one input and one output, in which case is scattering matrix is a two-dimensional matrix. In the example shown, S₁₁ and S₂₂ are reflection coefficients at ports 1 and 2 and S₁₂ and S₂₁ are the forward and backward transmission coefficients. The method assumes a low loss condition typical of circuit board or IC chip transmission lines 12. Under this low loss condition, the intrinsic impedance Z₀ is not affected by losses. If the scattering matrix is normalized to the intrinsic impedance of the structure (that is, if

$$( that is , if {Z}_{o} = \sqrt{\frac{L}{C}} ) ,$$

then S₁₁ and S₂₂ are zero. Thus,

$${S}_{21} = {S}_{12} = exp ( - \frac{π f \sqrt{{ϵ}_{r}^{′}} tan δ}{c} \cdot l ) ,$$

where f is the frequency (Hz) of the signal on the transmission line, c is the speed of light (3×10⁸ m/s), l is the length of the transmission line (in meters), εᵣ^{′} is the real part of the dielectric constant of the medium 10 material (or the effect of the dielectric constant), and tan

$$tan δ = \frac{{ϵ}_{r}^{″}}{{ϵ}_{r}^{′}} ,$$

where εᵣ^{″} is the imaginary part of the dielectric constant of the medium 10 material in which the transmission line 12 is embedded. Thus, in the example described above having two ports, the scattering matrix can be rewritten as follows:

$$[ S ] = [ \begin{matrix}0 & exp ( - \frac{π f \sqrt{{ϵ}_{r}^{′}} tan δ}{c} \cdot l ) \\ exp ( - \frac{π f \sqrt{{ϵ}_{r}^{′}} tan δ}{c} \cdot l ) & 0\end{matrix} ]$$

FIG. 5 shows a computer system 300 having a processor 310 connected to an input device 320 and a display device 330. The processor 310 accesses memory 340 in the computer system 300 that stores a circuit model 350. Circuit simulation software 360 is also stored in the memory 340. In use, the input device 320 receives commands instructing the processor 310 to call the software 360 to perform a circuit analysis on the model 350. The results of the analysis may be displayed on the display device 330.

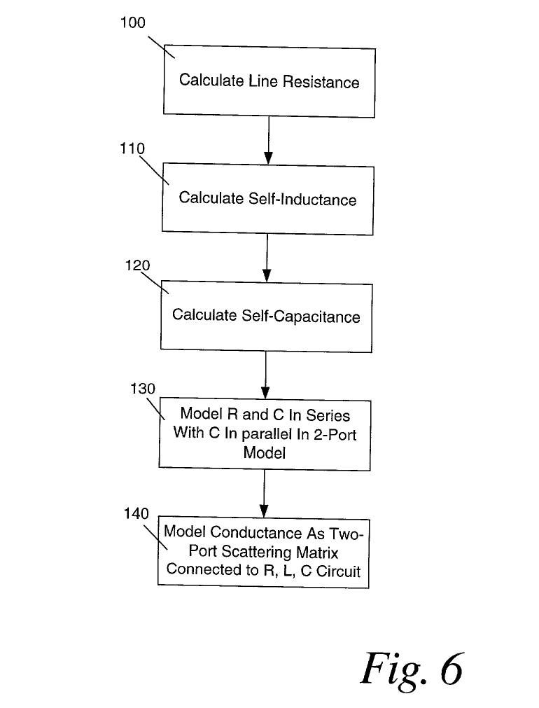

FIG. 6 shows a flow chart of the method for modeling dielectric losses. The method may be implemented in, for example, software modules stored within memory 340, or within any other computer-readable medium, for execution by a processor 310. The line resistance is calculated 100. The self-inductance of the line 12 is calculated 110. The self-capacitance is calculated 120. Each of these values may be calculated using conventional methods currently used to model the lumped circuit. These values are used to model 130 the R, L, C portion of a two-port lumped circuit model, where the resistance and capacitance are connected in series and the capacitance in parallel, as shown in FIG. 4. The frequency-dependent conductance is modeled 140 as a two-port scattering matrix connected in parallel with the self-capacitance. The model 350 can be stored in memory 340 and displayed on the display device 330.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

We claim:

1. A method of modeling dielectric losses in a transmission line, the method comprising:
modeling a resistance, a self-inductance, and a self-capacitance for a line as a lumped element circuit having a first port and a second port, where a signal is received on the first port; and
modeling a dielectric loss as a scattering matrix connected to the second port.

2. The method of claim 1, wherein the scattering matrix uses values based upon a low-loss condition wherein the intrinsic impedance of the line is unaffected by losses, whereby reflection coefficients for the first and second ports are defined to be zero if the scattering matrix is normalized to the intrinsic impedance.

3. The method of claim 1, wherein the scattering matrix uses values that vary with a frequency of the signal.

4. The method of claim 1, wherein the scattering matrix uses values that are related to the dielectric constant of a material in which the line is embedded.

5. The method of claim 1, further comprising calculating the resistance, inductance, and capacitance.

6. The method of claim 1, further comprising modeling a skin effect resistance and a skin effect inductance using an R-L tank circuit connected to the second port.

7. The method of claim 1, further comprising modeling the losses using circuit simulation software.

8. A method for simulating a transmission line comprising:
determining a resistance of a transmission line;
determining a self-inductance of the line;
determining a self-capacitance of the line;
creating a computer model of the line as a schematic having first and second ports;
modeling the resistance as a resistor in series with an inductor that represents the self-inductance;
modeling the self-capacitance as a capacitor connected to the line; and
modeling a dielectric loss as a scattering matrix connected to the second port, wherein the scattering matrix [S] represents conductance of the transmission lines across a broad band of frequencies.

9. The method of claim 8, further comprising modeling a signal received on the first port.

10. The method of claim 8, wherein the scattering matrix uses values that are related to the dielectric constant of a material in which the line is embedded.

11. The method of claim 8, wherein the transmission line is a line on an electronic circuit board or an integrated circuit chip.

12. The method of claim 8, wherein the line is simulated using circuit simulation software.

13. The method of claim 8, wherein the step of modeling the dielectric loss comprises using a two-by-two matrix described as:
$$[ S ] = [ \begin{matrix}0 & exp ( - \frac{π f \sqrt{{ϵ}_{r}^{′}} tan δ}{c} \cdot l ) \\ exp ( - \frac{π f \sqrt{{ϵ}_{r}^{′}} tan δ}{c} \cdot l ) & 0\end{matrix} ] .$$

14. A computer-readable medium having computer-executable instructions for performing a method for modeling transmission lines, the method comprising:
modeling a resistance, a self-inductance, and a self-capacitance for a line as a lumped element circuit having a first and second port, where a signal is received on the first port; and
modeling a dielectric loss as a scattering matrix connected to the second port.

15. The medium of claim 14, wherein the scattering matrix uses values based upon a low-loss condition wherein the intrinsic impedance of the line is unaffected by losses, whereby reflection coefficients for the first and second ports are defined to be zero if the scattering matrix is normalized to the intrinsic impedance.

16. The medium of claim 14, wherein the scattering matrix uses values that vary with a frequency of the signal.

17. The medium of claim 14, wherein the scattering matrix uses values that are related to the dielectric constant of a material in which the line is embedded.

18. The medium of claim 14, wherein the method further comprises calculating the resistance, inductance, and capacitance, and wherein the steps of modeling comprise using circuit simulation software.

19. The medium of claim 14, wherein the method further comprises modeling a skin effect resistance and a skin effect inductance using an R-L tank circuit connected to the second port.

20. The medium of claim 14, wherein the step of modeling the dielectric loss comprises using a two-by-two matrix described as:
$$[ S ] = [ \begin{matrix}0 & exp ( - \frac{π f \sqrt{{ϵ}_{r}^{′}} tan δ}{c} \cdot l ) \\ exp ( - \frac{π f \sqrt{{ϵ}_{r}^{′}} tan δ}{c} \cdot l ) & 0\end{matrix} ] .$$
